(19) United States
(12) Patent Application Publication
(10) Pub. No.: US 2026/0355767 A1
(43) Pub. Date: Nov. 12, 2026

(54) PUMP DISPENSER

(71) Applicant: ALPLA WERKE ALWIN LEHNER GMBH & CO. KG, Hard (AT)

(72) Inventor: Sree Hari R. NAIR, Hyderabad (IN)

(21) Appl. No.: 19/135,108

(22) PCT Filed: Dec. 11, 2023
(86) PCT No.: PCT/EP2023/085143

§ 371 Date: Jun. 3, 2025

(30) Foreign Application Priority Data
Dec. 12, 2022 (IN) 202211071547

(51) Int. Cl. B05B 11/10; B65D 47/00; F04B 9/14

(52) U.S. Cl. CPC B05B 11/1047; B05B 11/1074; B05B 11/109; B65D 47/00; F04B 9/14

(57) ABSTRACT

A pump dispenser includes a housing, in which a dosing chamber is formed, a closure cap, and a pump head to carry out a pump stroke. The dispenser also has a piston, which is movable in the dosing chamber for conveying the liquid, a dispenser opening through which dosed liquid can leave the pump dispenser, and a spring, which returns the pump head relative to the housing. A valve defines the conveying direction of the liquid from the container into the dispenser opening and blocks conveyance in the reverse direction.

### FIELD OF THE INVENTION

The invention relates to a pump dispenser according to the preamble of claim 1.

### PRIOR ART

Pump dispensers are used for the dosed removal of a liquid, which can also have an increased viscosity (creams or gels), from a storage container by depressing a dispenser head. The dispenser extension is formed on the dispenser head and therefore moves along with the dispenser head. A spring is integrated into the dispenser for returning the dispenser head. The valve function which is necessary for the liquid to be conveyed into the dispenser extension when the head is pressed, and for the liquid to be sucked back into the pump dispenser when the head is returned to its previous position, is achieved by a ball. The dispenser head can therefore be linearly moved between an upper and a lower position and is automatically returned to the upper position by the spring. The dispenser head is displaceable relative to a closure cap which can be fastened to a container neck.

In particular for transport purposes, it is known from the prior art that the dispenser head can be secured in the lower position and an undesired pumping movement of the dispenser head is thereby prevented. To secure the dispenser head in the lower position, an external or an internal thread can be provided on the dispenser head, which external or internal thread interacts with an internal or an external thread formed on the closure cap. As a result, the dispenser head can be screwed in the lower position from the closure cap. However, the threads are inevitably visible in the upper position of the dispenser head, and therefore the appearance of the pump dispenser is not very aesthetic. The threads are also prone to contamination during use.

### OBJECT OF THE INVENTION

The disadvantages of the prior art described give rise to the object of providing a pump dispenser which has an aesthetic appearance.

### DESCRIPTION

In the case of a pump dispenser, the stated object is achieved by the features cited in the characterizing portion of claim 1. Developments and/or advantageous alternative embodiments form the subject matter of the dependent claims.

The invention is preferably characterized in that the device is achieved in that a first thread is spaced apart from the pump head by a spacer element and moves linearly together with the pump head and in that a second thread, which is arranged in the housing, interacts with the first thread in order to secure the pump head in the lower position. The first thread protrudes into the housing both in the upper and in the lower position of the pump head by means of the spacer element. The second thread is arranged in the housing anyway. As a result, the first and the second thread are invisible. The pump dispenser is thus provided with an attractive and aesthetic design without visible threads. Since the first thread protrudes into the housing in each position of the pump head, it is well protected against contamination and damage. In addition, the sealing of the piston rod relative to the housing is facilitated, as a result of which no contaminants such as shower water can penetrate the liquid received in the container from the outside.

In a particularly preferred embodiment of the invention, the spacer element is a first sleeve which is connected at its first end to the pump head and at the second end of which the first thread is formed. The sleeve has a smooth surface which is free of a thread or other elevations in the upper position of the pump head. The appearance of the first sleeve is accordingly pleasing and is also free of contamination. A sealing lip can slide reliably sealingly along the first sleeve.

It has proven expedient if the second thread is arranged in a second sleeve, which second sleeve is positioned in the housing. The second thread can be formed more easily on the second sleeve than on the housing. By inserting the second sleeve, the second thread is positioned at the required height in the housing. In addition, the second sleeve is used as a support for the spring.

It is preferred if the first thread is an external thread and the second thread is an internal thread. A reverse formation of the interacting first and second threads would also be conceivable. The embodiment preferred here allowed a simplified formation of the first and second threads.

In a further particularly preferred embodiment, the first sleeve and the piston rod are formed integrally. As a result, a production step can be omitted in which the first sleeve must be connected to the piston rod.

The spring is expediently positioned in a first cavity between the piston rod and the first sleeve. As a result, the first sleeve of the spring is not in the way during compression.

It is preferred if the base of the first cavity and the second end of the second sleeve provide supports for the spring. As a result, the first and the second sleeve fulfill the additional function of supporting the first and second ends of the spring.

A second cavity, in which a retaining extension of the pump head is secured, is expediently formed between the piston rod and the first sleeve. As a result, the pump head can latch on the piston rod or can be clamped instead of glued thereto.

The invention is also preferably characterized in that the first sleeve and the piston rod are connected to one another by a connecting piece. By providing the connecting piece, the first sleeve can be produced integrally with the piston rod and does not have to be subsequently connected to the piston rod.

In a further preferred embodiment of the invention, the connecting piece separates the first cavity from the second cavity and supplies the support for the spring. As a result, the connecting piece performs multiple functions at the same time in an elegant and efficient manner. Further assembly steps can be omitted during the production of the pump dispenser, since the piston rod, the first sleeve, the first thread and the connecting piece are formed integrally in an injection mold and the first and the second cavity are provided simultaneously.

It proves expedient if a first shoulder is formed at the first end of the second sleeve, which shoulder rests against the upper end of the housing and through which the second sleeve is positioned in the housing. As a result, the second thread receives its exact position in the housing by simply inserting the second sleeve into the housing.

In a further preferred embodiment of the invention, a sealing element is placed on the closure cap, which element seals the transition between the first sleeve and the housing. The sealing can take place, for example, with a sealing lip which slides along the lateral surface of the first sleeve when the pump head is displaced between the upper and the lower position. The seal reliably prevents contaminants from entering the interior of the container. If the liquid to be dispensed is a shower gel, washing water cannot penetrate into the container and dilute the shower gel.

It is preferred if the sealing element has the same outer contour as the side of the pump head which faces the sealing element, whereby the sealing element terminates flush with the pump head in the lower position. As a result, the pump dispenser has an attractive shape not only in the upper position of the pump head, but also in the lower position of the pump head. This is important in that the pump head assumes the lower locked position in the retail shelves and the elegant appearance of the pump dispenser can have an effect in terms of promoting sales.

Further advantages and features will become apparent from the following description of an exemplary embodiment of the invention with reference to the schematic representations, in which, in a representation not true to scale:

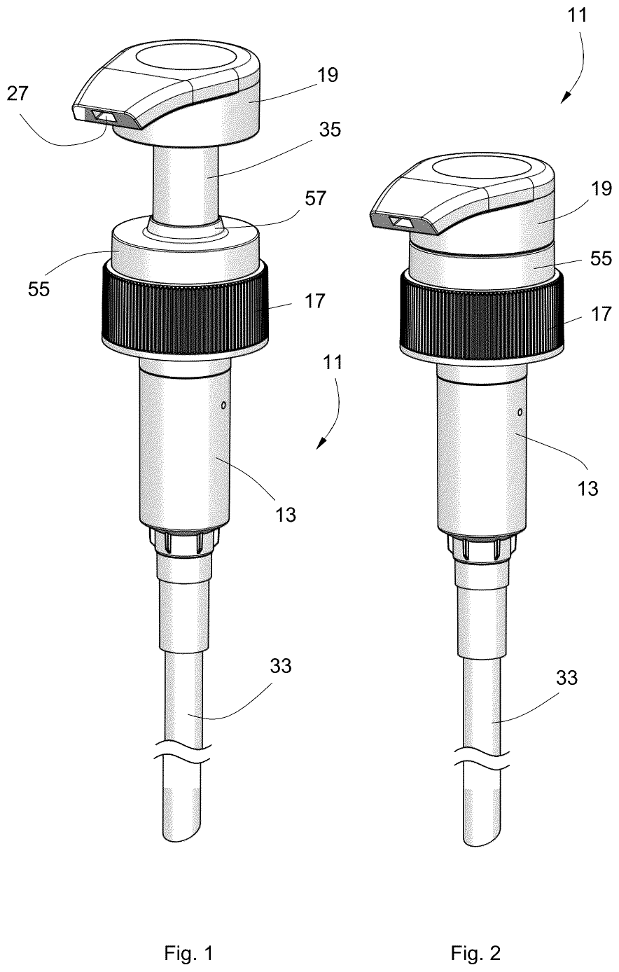

FIG. 1: is an axonometric view of a pump dispenser with a pump head in an upper position;

FIG. 2: is an axonometric view of the pump dispenser according to FIG. 1 in which the pump head is transferred into a lower position;

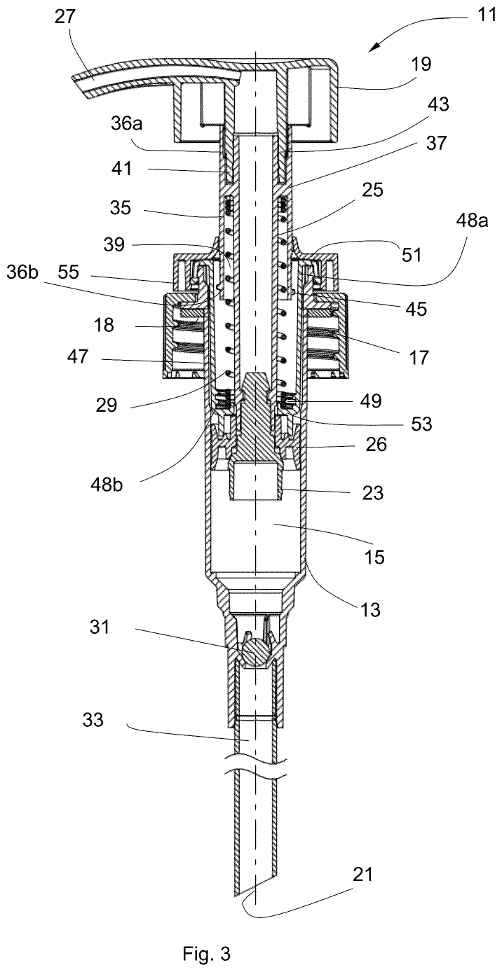

FIG. 3: is a sectional view of the pump dispenser with the pump head in the upper position, and

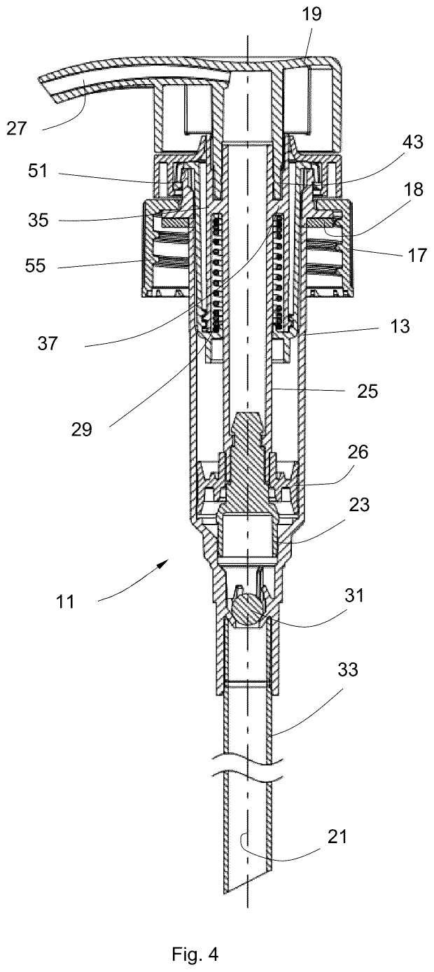

FIG. 4: is a sectional view of the pump dispenser with the pump head in the lower position.

FIG. 1 to 4 show a pump dispenser that is denoted as a whole by reference sign 11. By means of the pump dispenser 11, a liquid can be pumped from a container onto which the pump dispenser 11 is placed. The pump dispenser has a housing 13, in which a dosing chamber 15 is formed. A closure cap 17 is connected to the housing 13 and can be screwed on the container. A seal 18 is inserted into the closure cap for sealing against the container. As a result, the pump dispenser 11 is held on the container. A pump head 19 can be moved up and down between an upper and a lower position relative to the housing 13 along the longitudinal axis 21 of the dispenser 11 in order to carry out a pump stroke. A piston 23 is fixed to the pump head 19 via a piston rod 25 and slides with a piston seal 26 on the housing 13. The piston 23 can be moved up and down in the dosing chamber 15 for conveying the liquid. Dosed liquid leaves the pump dispenser 11 by means of a dispenser opening 27, which is connected to the dosing chamber via the hollow piston rod 25. A spring 29 returns the pump head 19 relative to the housing 13, since it is compressed in the lower position of the pump head 19 and automatically pushes back the pump head 19 into the upper position. A valve in the form of a ball 31 defines the conveying direction of the liquid from the container into the dispenser opening 27 and blocks conveyance in the reverse direction. The liquid is sucked into the dosing chamber 15 via a dip tube 33.

The pump head 19 can be secured in its lower position by the following device, whereby undesired pumping of liquid can be prevented, in particular when the container together with the pump dispenser 11 is transported: together with the piston rod 25, a first sleeve 35 is formed integrally on its outer face. The first sleeve 35 is connected to the piston rod 25 only with a connecting piece 37 and is spaced apart from said connecting piece. The piston rod 25 protrudes into the first sleeve 35 or is partially surrounded by the first sleeve 35. A first cavity 39 and a second cavity 41 are provided above and below the connecting piece 37, respectively, between the first sleeve 35 and the piston rod 25. At its first end 36a, the first sleeve 35 is connected to the pump head 19 by a retaining extension 43 of the pump head 19 being latched in the second cavity 41.

The first sleeve 35 has an external thread 45 formed at its second end 36b, as a result of which the external thread 45 is spaced apart from the pump head 19. A second sleeve 47, which likewise has a first and a second end 48a, 48b, is inserted into the housing 13. An internal thread 49, which interacts with the external thread 45, is formed at the second end 48b of the second sleeve 47. To this end, the pump head 19 is to be depressed into its lower position against the spring pressure 29. By rotating the pump head 19, the external thread 45 engages in the internal thread 49 and is screwed into it, whereby the pump head is secured in its lower position. The lower position can also be referred to as a transport position. By rotating the pump head in the opposite direction, the external thread 45 is unscrewed from the internal thread 49 and the pump head 19 can be pushed by the spring 29 into its upper position.

The second sleeve 47 has at its first end 48 a first radially outwardly protruding shoulder 51 which rests against the upper end of the housing 13. As a result, the second sleeve 47 and in particular the internal thread 49 is positioned at a certain height of the housing 13. At its second end 48b, the second sleeve 47 has a radially inwardly protruding second shoulder 53.

The spring 29 is accommodated in the first cavity 39. In this case, the connecting piece 37 and the second shoulder 53 provide a support for the spring 29 or its ends.

A sealing element 55, which seals the transition between the first sleeve 35 and the housing, is placed onto the closure cap 17. For a reliable watertight seal, a sealing lip 57 is formed on the sealing element 55, on which sealing lip the first sleeve 35 can slide when the pump head 19 is displaced. As a result, no water can penetrate the liquid in the container from the outside and dilute it. In particular when shower gels are filled, this is an advantage of the pump dispenser.

As can be seen clearly in particular in FIG. 1, neither the external thread 45 nor the internal thread 49 is visible from the outside. As a result, the pump dispenser 11 has an aesthetic appearance and the threads 45, 49 are protected against external contamination. The aesthetic appearance of the pump dispenser 11 is improved in the lower secured position of the pump head 19 in that the diameter of the sealing element 55 is equal to the diameter of the pump head 19. As a result, the transition between the pump head and the sealing element 55 is flush and continuous.

### LIST OF REFERENCE SIGNS

11 Pump dispenser
13 Housing
15 Dosing chamber
17 Closure cap
18 Seal
19 Pump head
21 Longitudinal axis
23 Piston
25 Piston rod
26 Piston seal
27 Dispenser opening
29 Spring
31 Ball, valve
33 Dip tube
35 First sleeve, spacer element
36a First end of the first sleeve
36b Second end of the first sleeve
37 Connecting piece
39 First cavity
41 Second cavity
43 Retaining extension
45 First thread, external thread
47 Second sleeve
48a First end of the second sleeve
48b Second end of the second sleeve
49 Second thread, internal thread
51 First shoulder
53 Second shoulder
55 Sealing element
57 Sealing lip

1.-13. (canceled)

14. A pump dispenser for the dosed removal of a liquid from a container onto which the pump dispenser can be placed, comprising:
a housing, in which a dosing chamber is formed,
a closure cap, which is connected to the housing and can be placed onto the container,
a pump head, which can be moved up and down between an upper and a lower position relative to the housing along the longitudinal axis of the dispenser in order to carry out a pump stroke,
a piston, which is fixed to the pump head by means of a piston rod, and can be moved in the dosing chamber for conveying the liquid,
a dispenser opening, which is connected to the dosing chamber and through which dosed liquid can leave the pump dispenser,
a spring, which returns the pump head relative to the housing,
a valve, which defines the conveying direction of the liquid from the container into the dispenser opening and blocks conveyance in the reverse direction and
a device for securing the pump head in the lower or the upper position, wherein
the device is achieved in that
a first thread is spaced apart from the pump head by a spacer element and moves linearly together with the pump head and in that
a second thread, which is arranged in the housing, interacts with the first thread in order to secure the pump head in the lower position.

15. The pump dispenser according to claim 14, wherein the spacer element is a first sleeve which is connected at its first end to the pump head and at the second end of which the first thread is formed.

16. The pump dispenser according to claim 14, wherein the second thread is arranged in a second sleeve, which second sleeve is positioned in the housing.

17. The pump dispenser according to claim 14, wherein the first thread is an external thread and the second thread is an internal thread.

18. The pump dispenser according to claim 16, wherein the first sleeve and the piston rod are formed integrally.

19. The pump dispenser according to claim 16, wherein the spring is positioned in a first cavity between the piston rod and the first sleeve.

20. The pump dispenser according to claim 19, wherein the base of the first cavity and the second end of the second sleeve provide supports for the spring.

21. The pump dispenser according to claim 16, wherein a second cavity is formed between the piston rod and the first sleeve, in which second cavity a retaining extension of the pump head is secured.

22. The pump dispenser according to claim 16, wherein the first sleeve and the piston rod are connected to one another by a connecting piece.

23. The pump dispenser according to claim 22, wherein the connecting piece separates the first cavity from the second cavity and supplies the support for the spring.

24. The pump dispenser according to claim 16, wherein a first shoulder is formed at the first end of the second sleeve, which first shoulder rests against the upper end of the housing and through which the second sleeve is positioned in the housing.

25. The pump dispenser according to claim 16, wherein a sealing element is placed onto the closure cap, which element seals the transition between the first sleeve and the housing.

26. The pump dispenser according to claim 25, wherein the sealing element has the same outer contour as the side of the pump head which faces the sealing element, whereby the sealing element terminates flush with the pump head in the lower position.
